(19) United States
(12) Patent Application Publication
(10) Pub. No.: US 2023/0410512 A1
(43) Pub. Date: Dec. 21, 2023

(54) AUTONOMOUS SAFETY VIOLATION DETECTION SYSTEM THROUGH VIRTUAL FENCING

(71) Applicant: Astoria Solutions Pte Ltd., Singapore (SG)

(72) Inventors: Dominic Loke, Singapore (SG); Kamatchi Kannan Ramkumar, Singapore (SG); Chun Ee Kho, Singapore (SG)

(73) Assignee: Astoria Solutions Pte Ltd., Singapore (SG)

(21) Appl. No.: 18/035,272

(22) PCT Filed: Nov. 4, 2021
(86) PCT No.: PCT/SG2021/050673

§ 371 Date: May 3, 2023

(30) Foreign Application Priority Data
Nov. 4, 2020 (SG) 10202010962S

(51) Int. Cl. G06V 20/52; G06V 40/10; G06T 7/73; H04N 5/91; H04N 7/18; G08B 13/196

(52) U.S. Cl. CPC G06V 20/52; G06V 40/10; G06T 7/74; H04N 5/91; H04N 7/183; G08B 13/19652; G08B 13/1968; G06T 2207/30196; G06T 2207/30232

(57) ABSTRACT

A virtual fencing system. The system includes one or more virtual fencing devices that include image sensors, capturing images of a region in the vicinity of boundary of a hazard area. The device may operate autonomously to detect one or more humans represented in captured images. The device may process images to determine position parameters of the human and compare those position parameters to the boundary to detect a safety event. Based on the severity of the event, the device may generate one or more outputs, which may be a local audible or visible alert or an electronic message sent to a remote user. The system may also archive or provide to a remote user addition information on the event, such as a snapshot of the human involved in the event, a video clip of the event or a video stream of the event.

### BACKGROUND

In most industrial facilities, there are hazardous areas with unsafe conditions. It may be necessary to prevent people from entering these areas to avoid the unsafe conditions or to prevent an accident from occurring. A physical fence may be erected around a hazardous area. In other scenarios, security personnel may be stationed to provide security in these areas, enforcing safety compliance by directing people away from the hazardous areas.

### BRIEF SUMMARY

In an aspect, a method for configuring a virtual fencing system comprising an image sensor may comprise: presenting an image on a user interface of a computing device, the image having been captured using the image sensor; receiving through the user interface a boundary; and storing, in connection with the image sensor, the boundary.

In some embodiments, the virtual fencing system may comprise a device, the device comprising: the image sensor; non-volatile memory; and a processor, coupled to the image sensor and the non-volatile memory, the processor configured to detect a human in an image captured with the image sensor, and the method may further comprise storing the boundary in the non-volatile memory.

In some embodiments, the method may further comprise storing, in the non-volatile memory, a plurality of boundaries, including the boundary; and each of the plurality of boundaries corresponds to a respective level of an alert system.

In some embodiments, a first level of the alert system may comprise an alert indicating a presence of a human in proximity of the boundary; and a second level of the alert system may comprise an alert indicating a breach of the boundary.

In some embodiments, the device may comprise a network interface; and the method may further comprise configuring the device to communicate through the network interface to a server.

In an aspect, a method of operating a device comprising a sensor to implement a virtual fence, wherein the sensor is configured to output information indicative of objects within a region, may comprise: processing output of the sensor to: identify a human in the region; and compute at least one position parameter of the human in the region; selectively, based on identifying the human in the region, storing sensor output; and selectively, based on a comparison of the at least one position parameter to a boundary within the region, outputting an indication of an event.

In some embodiments, outputting the indication of the event may comprise uploading the stored sensor output to a server.

In some embodiments, the sensor may output a stream of image frames; and selectively storing the sensor output may comprise: beginning to record the stream of image frames as a video based on determining that the human is represented in at least one image frame of the stream of image frames; repetitively processing image frames of the stream of image frames to determine whether the human is represented in the image frames; and based on determining that the human is no longer represented in the image frames, ending recording of the stream of image frames.

In some embodiments, computing the at least one position parameter of the human may comprise detecting a direction of motion of the human.

In some embodiments, the comparison of the at least one position parameter to the boundary may comprise determining whether the human breached the boundary.

In some embodiments, outputting the indication of the event may comprise transmitting an indication of a safety violation in conjunction with at least a portion of the stored sensor output.

In some embodiments, the portion of the stored sensor output may comprise a snapshot representing the human.

In some embodiments, the comparison of the at least one position parameter to the boundary may comprise determining whether the human is in proximity to the boundary.

In some embodiments, outputting the indication of the event may comprise activating an audible output device and/or a visible output device.

In some embodiments, outputting the indication of the event may comprise electronically transmitting a message comprising a warning of a safety violation.

In some embodiments, the region may comprise a facility entrance including a pedestrian lane and a vehicle lane; the boundary may be between the pedestrian lane and the vehicle lane; and outputting the indication of the event may comprise outputting an indication that the human has breached the boundary and/or entered the vehicle lane.

In an aspect, a method of operating a server of a virtual fencing system may comprise: receiving event data from a device, wherein the event data is associated with an event and indicates a position of a human with respect to a boundary; transmitting a message about the event to a user; receiving a request from the user for information about the event; receiving image information of the event from the device; and transmitting the image information to the user as a response to the request.

In some embodiments, receiving the image information of the event may comprise receiving a snapshot of the human.

In some embodiments, receiving the snapshot of the human may comprise receiving the snapshot with the event data.

In some embodiments, receiving the image information of the event may comprise receiving a video of the human.

In some embodiments, receiving the image information may comprise requesting the information subsequent to and based upon the request from the user for information about the event.

In some embodiments, receiving the event data may comprise receiving data indicative of a severity level of the event; and transmitting the message about the event may comprise selectively transmitting the message based on the severity level.

In an aspect, a device configured for implementing a virtual fence may comprise: one or more image sensors configured to output image frames; at least one processor coupled to the one or more image sensors; and a non-transitory computer-readable storage medium storing: a boundary, processor executable instructions that, when executed by the at least one processor, cause the at least one processor to perform: identifying a human in an image frame output by the one or more image sensors; computing at least one position parameter of the human based on a result of the identifying; and selectively transmitting a message based on a comparison of the at least one position parameter to the boundary.

In some embodiments, the device may comprise a power source configured to provide power to the one or more image sensors and the at least one processor.

In some embodiments, the power source may be a solar panel.

In some embodiments, the at least one processor may comprise a single-board processor; and the non-transitory computer-readable storage medium may comprise non-volatile memory on the single-board processor.

In some embodiments, the one or more image sensors may comprise at least one of a visible light sensor, an infrared radiation sensor, an ultrasonic sensor, a LIDAR sensor, a RADAR sensor, and a laser sensor.

In some embodiments, the device may further comprise a physical output device; and the processor-executable instructions may further cause the at least one processor to perform: selectively activating the physical output device based at least in part on the at least one position parameter.

In some embodiments, the physical output device may comprise at least one of a light, a horn, and a speaker.

In some embodiments, the processor-executable instructions further cause the at least one processor to perform: selectively storing a plurality of image frames output by at least one image sensor of the one or more image sensors based at least in part on the at least one position parameter.

In some embodiments, the processor-executable instructions further cause the at least one processor to perform: selectively transmitting the stored plurality of image frames based on the comparison of the at least one position parameter to the boundary.

In some embodiments, the processor-executable instructions further cause the at least one processor to perform: selectively transmitting a plurality of image frames output by at least one image sensor of the one or more image sensors as a video stream based on the comparison of the at least one position parameter to the boundary.

In some embodiments, the device may further comprise a network interface configured to implement a transport channel according to 4G, 5G, BLE, LAN, LORA, UWB, and point-to-point.

The foregoing features may be used singly or together, in any suitable combination.

### BRIEF DESCRIPTION OF DRAWINGS

FIG. 1A is a sketch of an environment where an exemplary virtual fencing system is implemented.

FIG. 1B is a schematic illustration of the environment of FIG. 1A.

FIG. 2 is an illustration of an of an exemplary virtual fencing device.

FIG. 3 is a functional block diagram of an exemplary virtual fencing system.

FIG. 4 is a schematic wiring diagram of an exemplary virtual fencing device.

FIG. 5 is a schematic illustration of coverage angles of sensors in an exemplary virtual fencing device.

FIG. 6 is a flowchart of an exemplary method for configuring a virtual fencing device.

FIG. 7A is a flowchart of an exemplary method of operating a virtual fencing device to output an indication of an event.

FIG. 7B is a flowchart of an exemplary method of operating a virtual fencing device to capture sensor output indicative of an event.

FIG. 8 is a flowchart of an exemplary method of operating a server of a virtual fencing system to make information about an event available to a user.

FIG. 9A is a sketch of an environment in which an exemplary virtual fencing system is implemented to monitor a boundary between a production plant and areas outside of the production plant.

FIG. 9B is a schematic illustration of the environment of FIG. 9A.

FIG. 10A is a sketch of an environment in which an exemplary virtual fencing system is implemented to monitor a boundary for a vehicle lane.

FIG. 10B is a schematic illustration of the environment of FIG. 10A.

FIG. 11A is a sketch of an exemplary virtual fencing system to monitor a boundary of an elevated structure.

FIG. 11B is a schematic illustration of the environment of FIG. 11B.

FIG. 12 is an example of a suitable computing system environment in which embodiments of the technology may be implemented.

### DETAILED DESCRIPTION

Described herein is a safety system that can be easily and economically installed, including at industrial sites, and can reduce or eliminate the need for a physical fence and/or security personnel. The system may implement a virtual fence, separating a hazardous area and a safe area. The system may include one or more virtual fencing devices that can be easily configured, based on user input, to monitor a boundary in the vicinity of a hazardous area using an output of one or more sensors.

Sensor output may be processed to recognize a human and to determine position parameters of the human. Based on the position parameters relative to the position of the boundary, the virtual fencing device may detect an event and initiate one or more actions.

Upon detecting that the human is approaching the boundary, for example, the virtual fencing device may initiate physical output, such as lights or sound, to warn the human of the hazardous area. In some embodiments, one or more additional boundaries may be monitored to detect whether the human is approaching the hazardous area. For example, the virtual fencing device may monitor the boundary that separates the hazardous area and the safe area, as well as an additional boundary at a specified distance from the hazardous area. Upon detecting that a human has crossed the boundary or has approached to within a predetermined distance, the virtual fencing device may determine that the human is approaching the hazardous area.

Alternatively or additionally, the virtual fencing device may communicate with a server which in turn may communicate with a user. The virtual fencing device, for example may transmit to the server a notification of an event. The server may communicate with a user, such as, for example, a safety officer. In some embodiments, the virtual fencing device may be configured to store configuration information and process sensor outputs to enable efficient communication with the server, while using relatively low network bandwidth. This decreases cost and latency, thus increasing reliability of the overall system.

In some embodiments, the system may differentiate between event types, such as a warning of a violation of a safety protocol or of a possible violation of a safety protocol. The system, in some embodiments, may differentiate events based on the position parameter of the human with respect to a boundary. For example, a human approaching or loitering near a boundary may generate a warning event, which may trigger physical output in the vicinity of the boundary without transmitting information to the server. Alternatively or additionally, upon detection of a warning event, a virtual fencing device may transmit a compact notification of the event (e.g., to the server). As another example, upon detection of a human breaching a boundary, the virtual fencing device may trigger physical output in the vicinity of the boundary, in addition to transmitting information to the server.

In some embodiments, upon detection of an event, the virtual fencing device may transmit additional information about the event, such as sensor information. The sensor information may enable a user receiving a notification of the event to learn more about the event. The sensor information, for example, may enable the user or a server processing the event notification, to recognize a specific human who triggered the event. In an industrial setting, for example, the user may be a security officer or a human resources representative of a company that may take corrective action with an employee of the company that has committed a safety violation.

In some embodiments, the transmitted sensor information may be formatted as a snapshot of the human involved in the event. For example, upon detection of an event, the virtual fencing device may select an image frame output by a sensor representing the face of the human that triggered the event. This image frame may be transmitted to the server as a record of the event. Alternatively or additionally, the virtual fencing device may transmit a stream of image frames, which may be formatted as a video recording of the event.

In some embodiments, image and/or video information may be transmitted selectively. For example, a virtual fencing device may transmit image and/or video information selectively based on the type of event. Information requiring more network bandwidth, for example, may be transmitted in connection with violation events, but not warning events. As a specific example, a video may be transmitted in connection with a violation event, but not in connection with a warning event. As another example, a shorter video clip may be transmitted in connection with a warning event and a longer video may be transmitted in connection with a violation event. Alternatively or additionally, the virtual fencing device may transmit image and/or video information selectively based on user input. For example, a user may, upon notification of a violation, request video, which may trigger the virtual fencing device to transmit a video clip or to live stream video from a sensor on the device.

The inventors have recognized and appreciated that in industrial plants, where safety compliance is important, it may not be feasible to place a physical fence or to rely on human monitoring between a hazardous area and a safe area. A virtual fencing system as described herein may create an autonomous safety violation detection system that creates a line of violation. The system may detect humans passing through the line and may also be able to distinguish between humans and other objects.

In some embodiments, the system may include one or more virtual fencing devices that operate as autonomous safety violation detection devices. These devices may communicate with a server that, among other functions, provides a user interface. The system may receive user inputs through the user interface, such as to configure each of the one or more virtual fencing devices with a boundary from which a line of intrusion may be determined or to request additional information about an event. The system may also provide outputs via the user interface. The output may include notifications of or information about a detected event.

An autonomous safety violation detection device may be configured to monitor safety violations by a virtual fencing control unit, which may include: a virtual fencing module having an output wherein the module is configured to produce the safety violation output when a human object is detected to pass through a line of violation between a safe area and a hazardous area in an industrial plant; a transmitter module which is configured to look for the new safety violation event and transmit the event comprising safety violation status information selectively based on the output of the safety violation algorithm; and a camera module for recording live video footage and video streaming.

The system can be packaged as a unit which can be deployed in the field with an independent power source and independent data transport channel to the server.

In some embodiments, the virtual fencing system may include an autonomous safety violation detection device configured to monitor safety violations by a virtual fencing control unit including a virtual fencing module having an output wherein the module is configured to produce the safety violation output when a human object is detected to pass through a line of violation between a safe area and a hazardous area. In some embodiments, the virtual fencing system may further include a processing module, which is configured to create output based on output of a camera that indicates a safety violation (e.g. a human breaching a line of violation) and selectively transmit to a server event-related information comprising safety violation status information. In some embodiments, the event-related information may be selected for transmission based on the output of a safety violation algorithm executing on a processor in the autonomous safety violation detection device.

In some embodiments, the virtual fencing module of the autonomous safety violation detection device may include an intelligent single-board processor which converts a live video stream into frames and analyzes the presence of a safety violation event or intrusion event based on the frames and the configured intrusion identification method. This is unlike typical video analytics systems, which transmit live video to a server to detect an intrusion, and therefore require higher bandwidth to transmit the live video.

### Virtual Fencing System

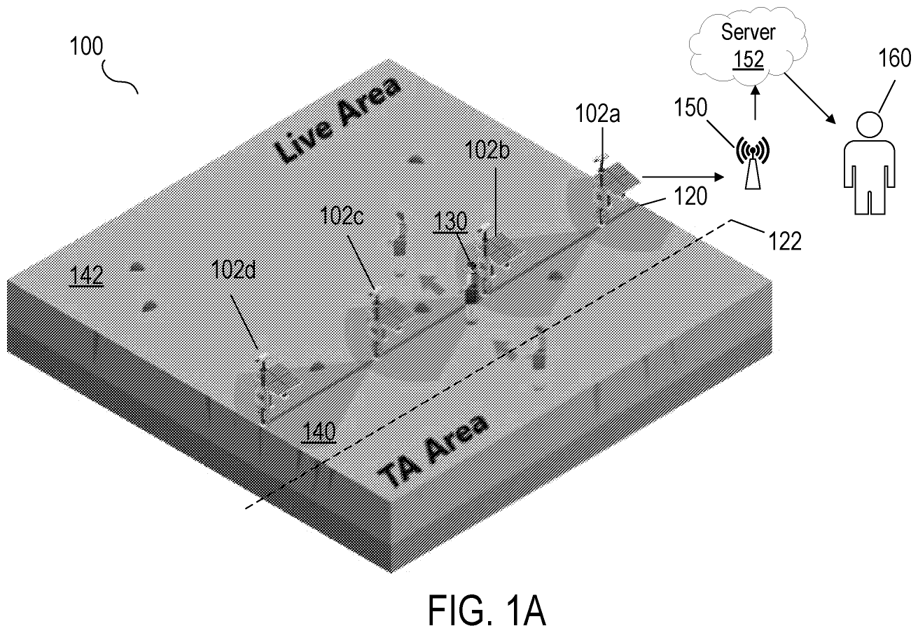

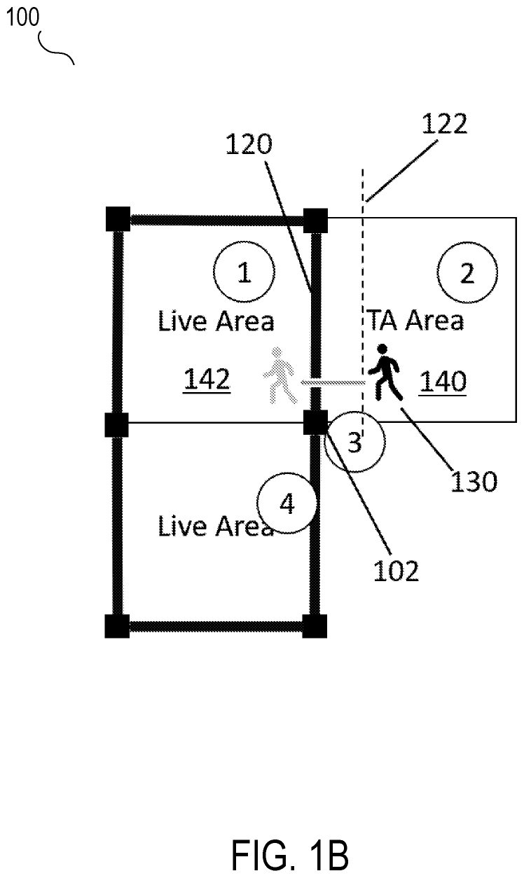

An example environment 100 in which a virtual fencing system may be implemented is illustrated in FIG. 1A, while a schematic illustration of FIG. 1A is illustrated in FIG. 1B. The environment 100 includes virtual fencing devices 102a-d which are used to establish boundary 120 between a safe area 140 and a hazardous area 142. The devices 102a-d are configured to capture a safety violation event, which may occur when a human 130 crosses or nears boundary 120. A virtual fencing system may also include a server 152, wirelessly connected to the devices 102a-d via network interface 150. In this example, devices 102a-d are shown coupled to a single network interface 150. However, it should be appreciated that each device may have its own network interface 150 and that, in some embodiments, the network interface 150 may be internal to the device.

The server 152 is configured to perform one or more functions, such as: receive event data relating to safety violation events, activate a notification system to send messages and alert one or more recipients 160, and/or store the event data. In this example, server 152 is a network-connected server accessible over a wide area network, such as the internet. In some embodiments, server 152 may be a cloud server. Alternatively or additionally, server 152 may be a computing device that has access to cloud data storage. In such an embodiment, devices 102a-d may transmit information to server 152 by storing it in cloud data storage accessible to server 152. Such a transaction may be completed by, for example, calling a cloud storage application programming interface (API).

Devices 102a-d may also be configured to define additional boundary 122 or include additional boundary 122 by default. Additional boundary 122 may define a wider or more expansive region in which to detect a safety event. In some embodiments, the system may respond to a human crossing boundary 122 differently than a human crossing boundary 120. Crossing boundary 120, for example, may be treated as a violation, while crossing boundary 122 may be treated as a warning event. The system outputs, and actions taken, may differ based on event type.

In some embodiments, one or both boundaries may be specified by user input. For example, a user may be presented with an image acquired by an image sensor on a virtual fencing device 102a-d. The user may specify the position of one or more boundaries in that image. For example, the user may specify just the position of boundary 120, and the system may compute boundary 122 as an offset from the defined boundary. Alternatively or additionally, one or more boundaries may be defined by default based on the field of view of the image sensor. For example, the position of boundary 120 may be defined as the center of the field of view of the image sensor, while the position of boundary 122 may be defined as one or more edges of the field of view of the image sensor. For example, boundary 122 may be considered to have been crossed when a human enters the field of view of the image sensor. In these embodiments, the boundaries may be defined by the characteristics of the image sensors and their mounting within environment 100. Example characteristics may include, a sensor type, a mounting height, a mounting angle, a direction, a focus, or any other suitable characteristic, as embodiments of the technology are not limited in this respect.

In some embodiments, as shown in FIG. 1A, when a human 130 crosses the additional boundary 122, the virtual fencing devices 102a-d may capture a safety event. The data relating to the safety event may be sent by the virtual fencing device to the server 152 via network interface 150. Server 152 may then activate a notification system to alert one or more recipients 160 and/or store data in cloud storage. In some embodiments, the additional boundary 122 may include everything within the field of view of the devices 102a-d (i.e., if a human enters the field of view of any of devices 102a-d, they have crossed boundary 122.) Additionally or alternatively, the additional boundary 122 may include only a portion of the region included within the field of view.

In some embodiments, a safety event may be categorized based on the level of severity of the safety event. For example, a first level of an event may comprise a warning if a human 130 is within proximity of boundary 120 and has breached additional boundary 122. A second level of alert may comprise a breach of boundary 120 from the safe area 140 to hazardous area 142.

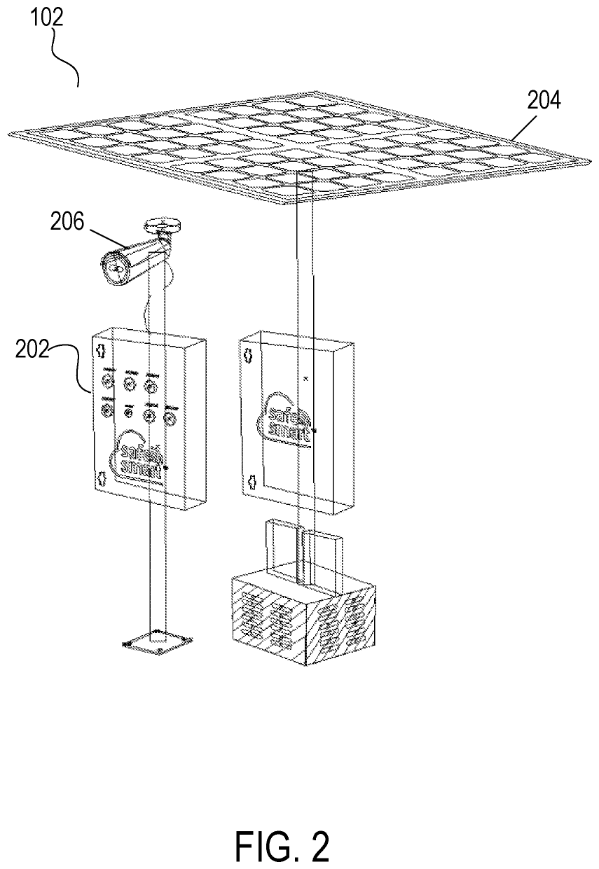

Each of the virtual fencing devices 102a-d may operate independently, but all may have the same configuration. An illustration of an example embodiment of device 102, which may be any of the virtual fencing devices 102a-d, is shown in FIG. 2. The virtual fencing device 102 includes one or more image sensor(s) 206, power source 204 and a module 202 comprising additional components, as described herein, such as a processor, and/or a user interface, for example. In some embodiments, the power source 204 may be an independent power source, which does not require separate wiring to a remote power source, such as a solar panel and/or a battery. In some embodiments, the device 120 may include the components needed to autonomously monitor the boundary 120, detect a safety event, store information related to the safety event, and transmit the safety event data to server 152.

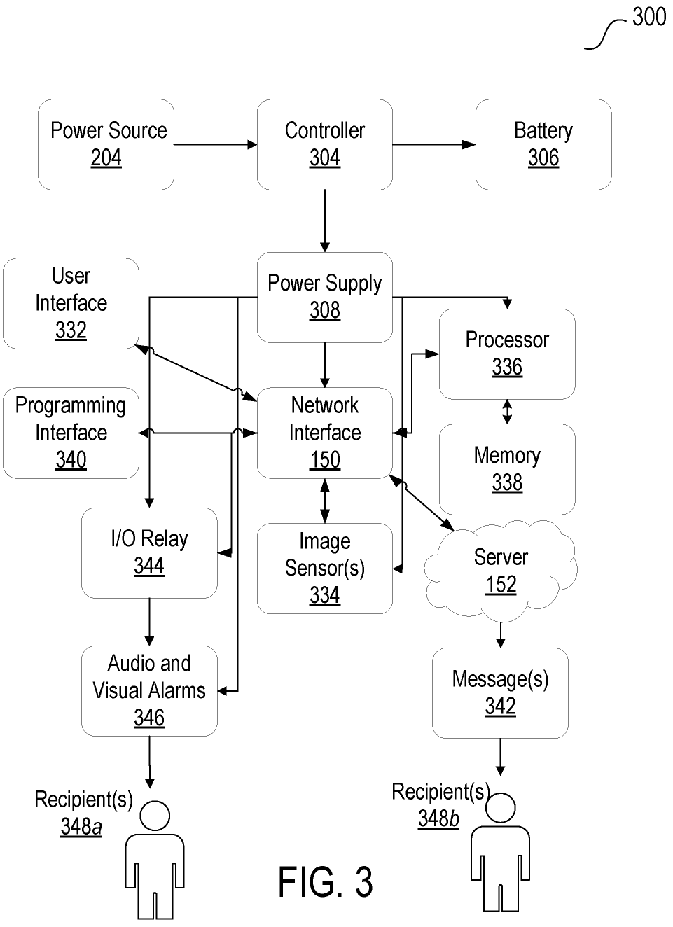

FIG. 3 is a functional block diagram of an exemplary virtual fencing system 300. The virtual fencing system 300 may include power source 204 coupled to controller 304, such that controller 304 manages and directs the power to battery 306 and power supply 308. In some embodiments, power supply 308 may be used to power processor 336, network interface 150, image sensors 334, input/output (I/O) relay 344, and the audio and visual alarms 346. The virtual fencing system may further include user interface 332, memory 338, programming interface 340 and server 152, which is configured to send messages 342 to alert recipient(s) 348a or 348b. In this example, recipient 348a may be a human in the vicinity of a hazard and may receive a message in the form of a warning light or warning horn. Recipient 348b may be a user of the system 300 that receives an alert that a human has approached or crossed a boundary. Recipient 348b may be remote from the hazard and may receive a message as an electronic communication.

Some of the components illustrated as part of system 300 may be integrated into a virtual fencing device, such as device 102. For example, power source 204, controller 304, battery 306, power supply 308, processor 336, network interface 150, input/output (I/O) relay 344, audio and visual alarms 346, image sensor(s) 334, and memory 338 may be part of a virtual fencing device that is installed in the vicinity of a hazard area. The virtual fencing system may include other components remote from the hazard area or remote from the virtual fencing device that interact with the virtual fencing device via network interface 150. These remote components may include user interface 332, programming interface 340 and server 152. In some embodiments, user interface 332 and programming interface 340 may be separate from server 152. In other embodiments, some or all of the interfaces may be implemented by programming on server 152, which may transmit and receive inputs using a web-based protocol. Alternatively or additionally, the I/O relay 344, which may be triggered to activate an output, may be remote and similarly connected through network interface 150. Likewise, communication with image sensor(s) 334 may also be through network interface 150.

Network interface 150 may be configured to facilitate communication between processor 336 and one or more other components, such as user interface 332, image sensor(s) 334, server 152, and I/O relay 344. Network interface 150 may be configured to implement independent data transport channels including, but not limited to, 4G, Bluetooth Low Energy (BLE), Local Area Network (LAN), Long Range Wide Area Network (LORA), Ultra-wideband (UWB), and point-to-multiple-point. It should be appreciated that different data transport channels may be used for different communications and/or at different times.

User interface 332 may be any suitable user interface used to configure virtual fencing system 300. In some embodiments, user interface 332 may receive one or more image frames from image sensor(s) 334 and present those images to a user. User interface 332 may then receive inputs from the user, designating the position of one or more boundaries, which are used to configure one or more boundaries recognized by the device, such as boundary 120 and/or additional boundary 122. Further, user interface 332 may be used to assign levels of severity to the one or more boundaries, as discussed with respect to FIGS. 1A-B. In some embodiments, the user interface 332 may be implemented by a separate computing device (including a mobile device, for example) configured to communicate with server 152, such that server 152 may receive user inputs or send notifications to a user upon detection of a safety event.

In some embodiments, as described herein, image sensor(s) 334 are configured to acquire images in the vicinity of the one or more boundaries. Any suitable sensor technology may be used including, but not limited to, visible spectrum video, infra-red video, ultrasound, Light Detection and Ranging (LIDAR), Radio Detection and Ranging (RADAR), and laser. For example, image sensor(s) 334 may include one or more visual light cameras. In some embodiments, image sensor(s) 334 may be configured to capture images at a pre-defined frame rate. In some embodiments, a user may define the frame rate through user interface 332 or the frame rate may be set to a default frame rate. Alternatively or additionally, regardless of the rate at which frames are generated by image sensor(s) 334, processor 336 may process a subset of the image frames, resulting in a lower effective frame rate. In some embodiments, image sensor(s) 334 may output a stream of image frames that are received by processor 336 coupled to the image sensor(s) 334. In some embodiments, memory 338 may be capable of recording video of a stream of image frames captured by the image sensor(s) 334. In some embodiments, processor 336 may be controlled to selectively store image frames to reduce the total amount of memory consumed by stored image frames. Alternatively or additionally, image frames may be stored in memory 338 and then processed. After processing, some or all of the image frames may be deleted, based on whether those image frames are retained for potentially reporting of a detected event.

In some embodiments, virtual fencing system 300 may include one or more tangible, non-transitory computer-readable storage devices storing processor-executable instructions, and one or more processors, as illustrated by processor 336, that execute processor-executable instructions to perform the functions described herein. Instructions may be stored in memory 338 or other memory contained within or coupled to processor 336. In some embodiments, processor 336 may be a single board processor that is configured to process image frames to detect a human within an image frame and to process one or more image frames to detect position parameters for the human. In some embodiments, the computer readable storage medium comprises non-volatile memory on processor 336.

Processor 336 may be in wireless communication with server 152 via network interface 150. In some embodiments, processor 336 may be configured to transmit data related to one or more safety events to server 152. In some embodiments, processor 336 may store the data related to one or more safety events in memory 338. In some embodiments, memory 338 may include one or more pre-configured data structures for storing data related to one or more safety events. In some embodiments, a first data structure may be configured to store a video of a safety event and a second data structure may be configured to store a snapshot and other related event data for immediate notification purposes. In some embodiments, processor 336 may upload the data to server 152 and then purge the data from memory 338.

Server 152 may be configured to execute one or more tasks upon receiving data related to the safety events, as described herein. In some embodiments, server 152 may be configured to activate a notification system to send notifications to be sent to one or more recipient(s) 348b. For example, message(s) 342 including, but not limited to, short message service (SMS), e-mail, voicemail, WhatsApp, Telegram and push notifications may be sent to a device or to user interface 332, such that the messages may be received by recipient(s) 348b.

In conjunction with the sending of messages to a recipient 348b, who may be remote from the hazard area, processor 336, as it is configured to detect safety events, may alert a recipient 348a who is in the hazard area. For example, processor 336 may activate I/O relay 344 to activate audio and visual alarms 346 including, but not limited to a light, horn, speaker, or any other suitable audio or visual alarm, as aspects of the technology described herein are not limited in this respect.

In some embodiments, the notification system may output different message(s) 342 and activate different audio and visual alarms 346 based on the level of severity of the safety event. For example, if human 130 is within proximity of boundary 120 and has breached additional boundary 122, message(s) 342 may be sent to recipient(s) 348b, but no audio and visual alarms 346 may be activated, or vice versa. As another example, if human 130 has breached boundary 120, message(s) 342 may be sent to recipient(s) 348b, and audio and/or visual alarms 346 may be activated. In some embodiments, a notification module may include a method to configure the notification to be sent based on the severity of the safety event or upon detection of a safety event. For example, inputs supplied through programming interface 340 may be stored within a virtual fencing device that define a relationship between position information of a human detected in images and event severity, such as a warning or a more severe violation. The types of notifications sent and/or physical output devices activated in each case may be similarly received and stored. The stored relationships may be applied by processor 336 to detect an event as it processes sensor information.

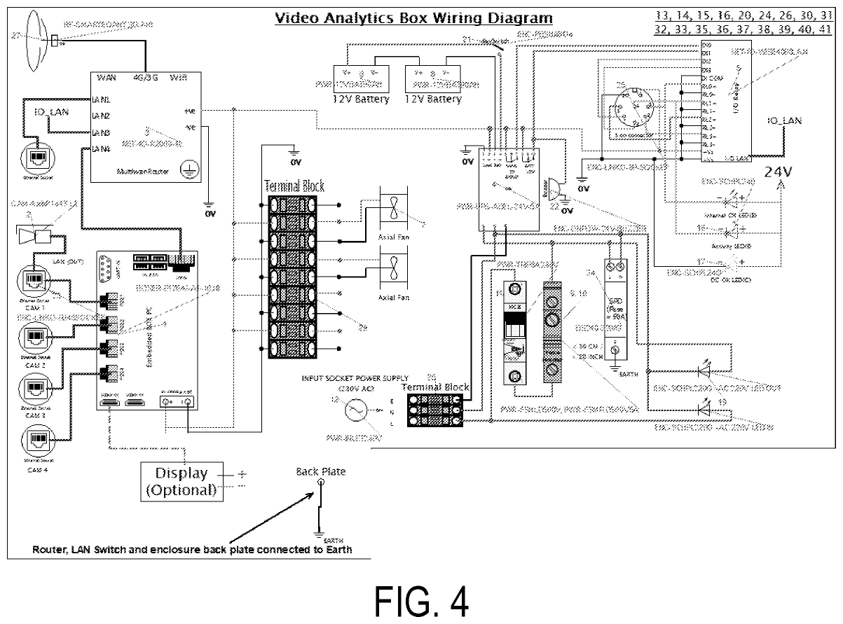

FIG. 4 is a schematic wiring diagram of an example of device 102 as described with respect to FIGS. 1-3. It provides a non-limiting example of the possible connections made between components within a module 202, for example.

In some embodiments, virtual fencing device 102 may be an autonomous device that can be moved and placed in any desirable location, as described herein. For example, device 102 may be placed in a region where the user desires to establish one or more boundaries.

Once device 102 is physically placed, parameters of image sensor(s) 334 may then be configured to establish and monitor the one or more boundaries. For example, parameters such as height at which the camera or other image sensor(s) 334 is mounted, angle that the camera or other image sensor(s) 334 is positioned, and/or focus of the camera or other image sensor(s) 334 configured will impact the cover distance of the line of violation (e.g. boundary 120) in visible spectrum video. In the example of a visible light camera used as an image sensor, the cover distance of the line of violation (e.g. boundary 120) in visible spectrum is also dependent on the environmental factors such as elevation, existence of corners, and/or existence of obstacles blocking the view of the camera. To cover all these factors, the image sensor(s) 334 may be positioned in a strategic location and more virtual fencing units (devices 102a-d) might be used to provide appropriate coverage of the line of violation (e.g., boundary 120). Alternatively or additionally, multiple image sensors, with different coverage regions may be used on each of the devices 102a-d.

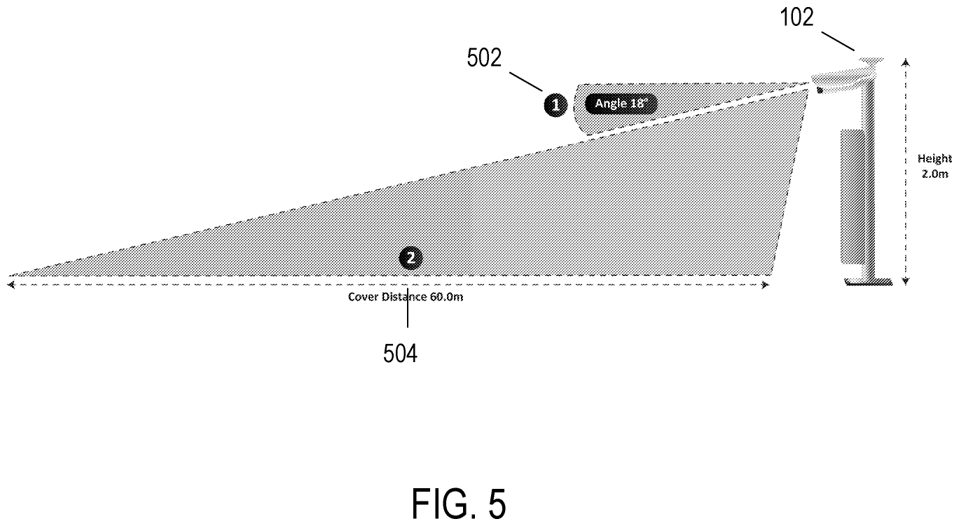

FIG. 5 illustrates an exemplary embodiment for configuring a device 102. In some embodiments when, a visible light camera is used as an image sensor(s) 334, the camera may be set at a height of 2 m+/−20%, camera angle 502 of 18 degrees+/−20%, and camera focus of around 7.7 mm+/−20% as illustrated in FIG. 5. In the illustrated example, the camera (image sensor(s) 334) can cover a maximum distance 504 of 60 m for the line of violation (e.g., boundary 120). The inventors have found that these dimensions are highly desirable, considering factors such as coverage, accuracy, etc.

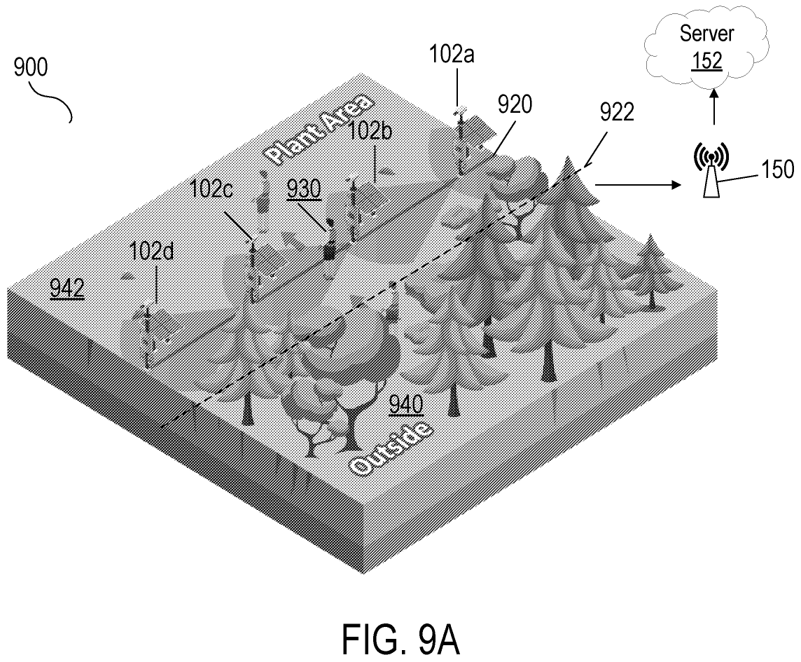

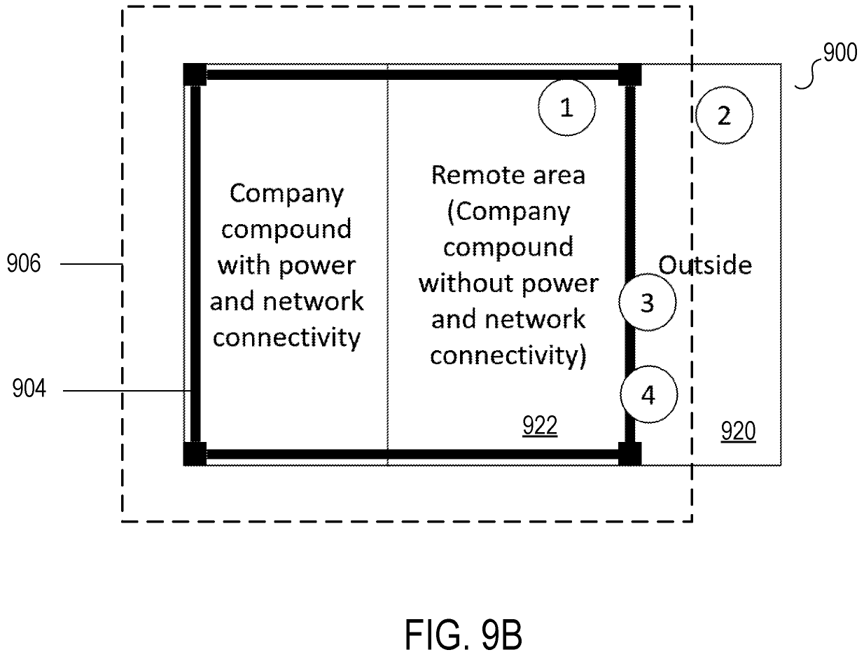

In this example, if the required distance to cover is more than 60 m, additional virtual fencing units (devices 120a-d) can be deployed to increase the range of the cover distance which is illustrated in the example embodiments of FIG. 1A and FIG. 9A, as described herein.

In some embodiments, if multiple image sensor(s) 334 are used to cover an uneven area within a short distance, outputs of multiple of the image sensor(s) 334 can be sent to a single virtual fencing unit (e.g. a device 120) to process the data.

Table 1 shows an example of how the cover distance of the line of violation (e.g. boundary 120) can be affected by the height, angle and focus of a visible light camera, which may be used as an image sensor 334.

TABLE 1

| | Height | Camera angle | Focus | Cover distance |
|---|---|---|---|---|
| Mode | (m) | (°) | (mm) | (m) |
| Setup 1 | 1.8 | 10 | 4.2 | 35 |
| Setup 2 | 2 | 18 | 7.7 | 60 |
| Setup N | . . . | . . . | . . . | . . . |

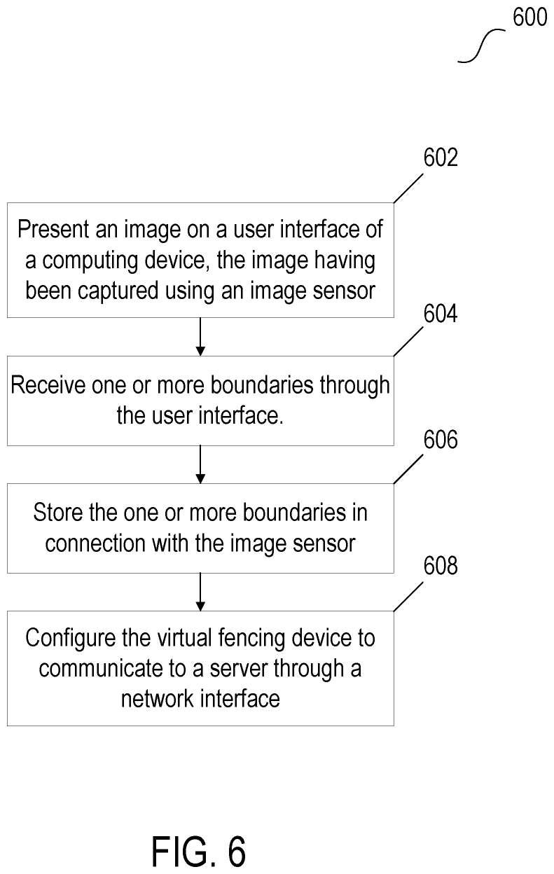

After placing one or more devices 102 to monitor regions including the desired boundaries, example method 600, as illustrated in the flowchart of FIG. 6, may be used to configure a device 102. At step 602, the virtual fencing system 300 presents an image captured with image sensor(s) 334 on user interface 332 of a computing device. As described above, the communication through the user interface 332 may be as a result of communication to a server 152, or other computing device over a network, which implements a user interface. Alternatively or additionally, a device 102 may include a display or other hardware components that may be directly controlled to provide a user interface.

With an image displayed on user interface 332, virtual fencing system 300 may receive one or more user inputs specifying boundaries through user interface 332 at step 604. For example, the one or more boundaries may include boundary 120 and additional boundary 122, as described with respect to FIGS. 1A-B. Alternatively or additionally, in some embodiments, computer executable instructions when executed by processor 336 or a processor in server 152 or other computing device may identify the one or more boundaries within the captured image without any input from the user. Image analysis may be used to identify ledges or other dangerous height transitions, warning signs or other markings or other indications of hazardous areas and define boundaries with respect to these image features.

After receiving the one or more boundaries through the user interface, step 606 includes storing the one or more boundary in memory 338. In some embodiments, the stored boundaries may be related to positions in image frames output by the image sensor, such that the boundaries can be identified in each image frame without further input from a user.

Other configuration operations may be performed. For example, example method 600 includes step 608 for configuring the device 102 to communicate to server 152 through network interface 150. In some embodiments, programming interface 340 may be used to define the interactions between device 102 and server 152. In some embodiments described herein, a preconfigured data storage location, such as a folder in memory 338, may be used to store data on device 102, which may continuously investigate the folder for new data. When new data is stored in the folder, programming interface 340 may be called to define interactions on device 102, server 152, or between device 102 and server 152. For example, in some embodiments described herein, a video may be recorded and stored in the pre-configured folder before being uploaded to server 152. As another example, a snapshot may be captured by image sensor(s) 334 for immediate notification purposes and stored in a different pre-configured folder.

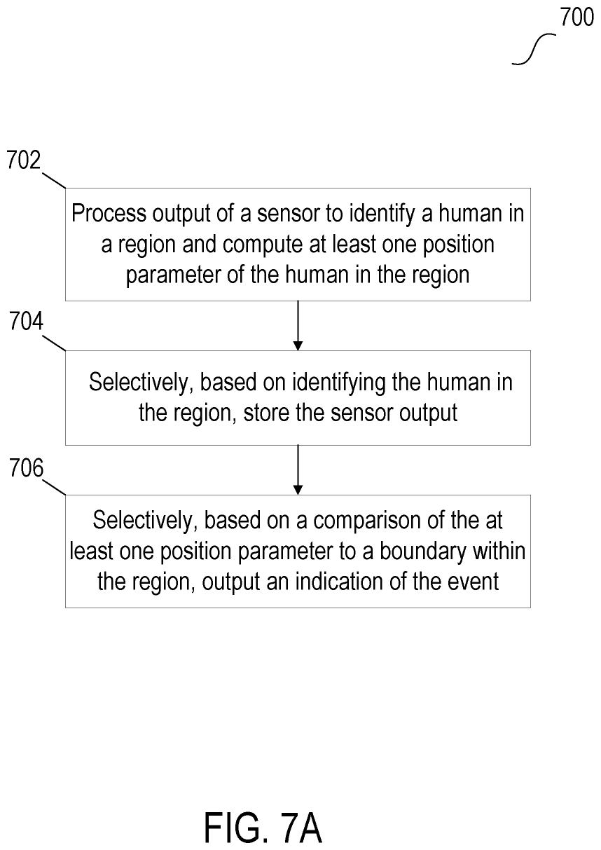

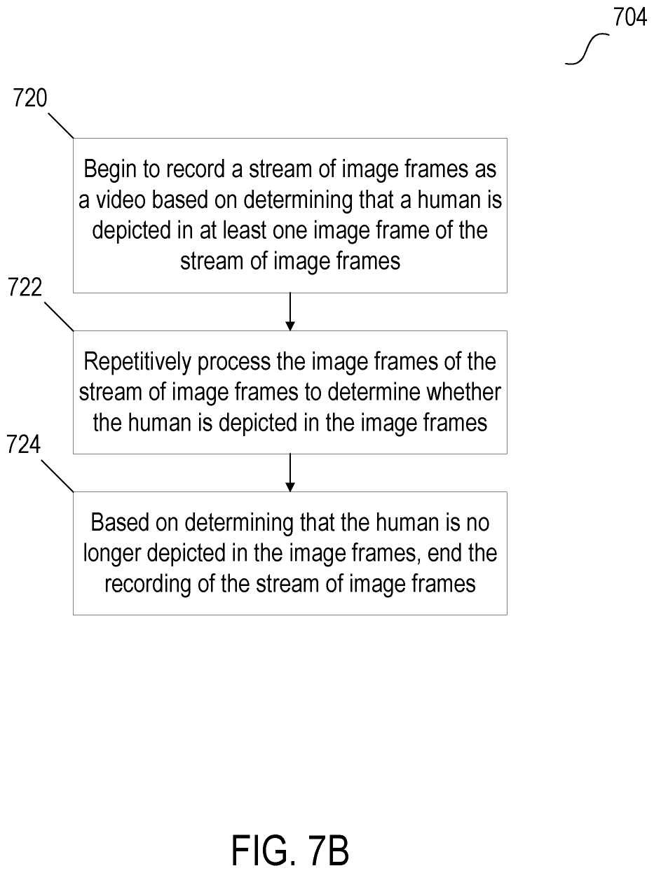

FIG. 7A is a flowchart of an example method 700 for operating a virtual fencing device 102. At step 702, example method 700 comprises processing output of image sensor(s) 334 to identify a human in a region and compute a position parameter of the human. In some embodiments, that region may be the entire region represented by an image frame from an image sensor. In other embodiments, the region may be defined by configuring the device, such as specifying a boundary, such as boundary 120 and/or additional boundary 122, as described above.

In some embodiments, the output of the image sensor(s) 334 may comprise one or more image frames captured by image sensor(s) 334, as described herein. In some embodiments, processing the image sensor output may comprise receiving the output at processor 336, which executes processor executable instructions, stored in memory 338, for identifying a human in an image frame and computing a position parameter. In some embodiments, the processor executable instructions may be a machine learning model. For example, the processor executable instructions may be a machine learning model from TensorFlow libraries.

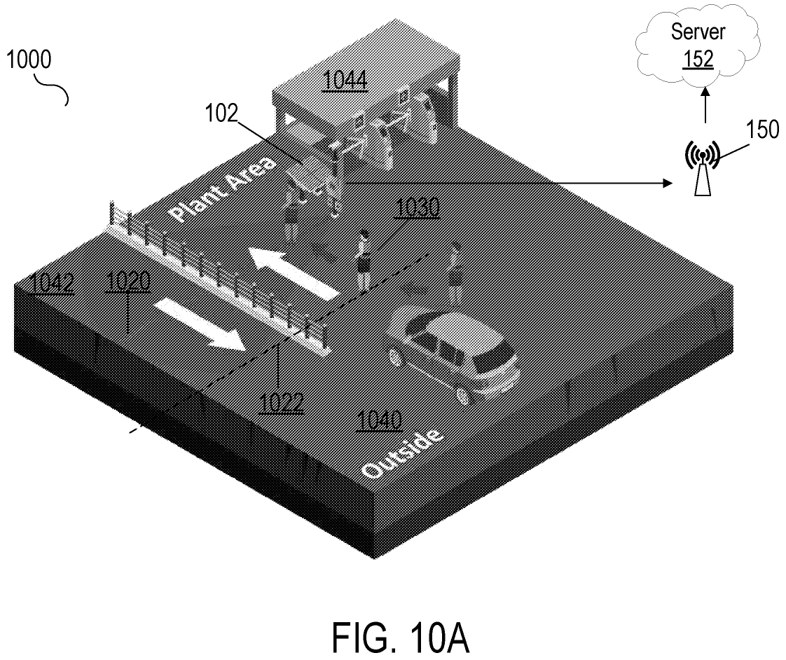

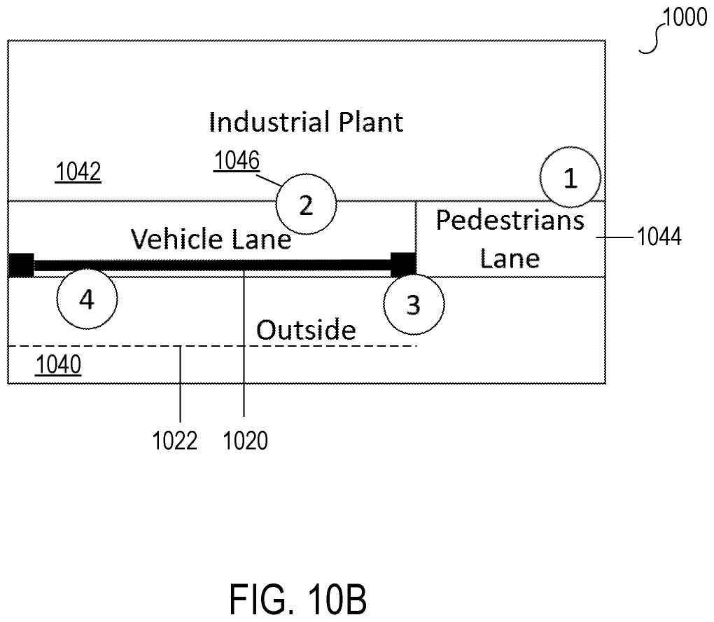

In some embodiments, identifying a human in a region may include using a machine learning model to identify an object in an image frame and then distinguishing between human and non-human objects. For example, it may be desirable to distinguish between cars and pedestrians, as described with respect to FIGS. 10A-B. In some embodiments, such a method to distinguish a human from other moving objects through a pre-trained model is used to avoid the needs of human intervention to classify a false alarm.

In addition to detecting a human in an image frame output by an image sensor, processing of the sensor output may include determining one or more position parameters of the human. A position parameter may include parameters such as: coordinate(s), direction of motion, velocity, and/or loitering time. In some embodiments, computing a position parameter of a human may comprise identifying coordinates of a human within each image frame output by the image sensor(s) 334. The coordinates of the human object may be defined by 4-point co-ordinates (e.g., X1, Y1, X2 and Y2). In some embodiments, the coordinates may be updated with each image frame, and the position parameters may be computed from the coordinates over time. In some embodiments, through comparing the position of the human objects in the various frames, the system may identify the difference in the position and conclude the direction of the human movement. For example, if the human in a first frame has the coordinate of (X:2, Y:0), and the human in a second frame has the coordinates of (X:5, Y:0), then the difference between the two coordinates is calculated and the human is concluded to have moved from left to right. As a non-limiting example, a virtual fencing module may comprise an algorithm to detect the direction of human movement between a safe area and a hazardous area in an industrial plant. Regardless of the nature of the position parameters detected, events may be configured, such as through user input or otherwise, based on these position parameters. For example, a warning event may be specified as a human loitering within a pre-defined distance of a boundary while a more severe violation event may be specified as a human crossing a boundary and/or being within a pre-defined distance of the boundary and moving towards the boundary at a speed above a threshold speed.

As a non-limiting example of step 702, the image sensor(s) 334 may continuously feed the processor 336 with images based on the pre-configured frame rate. Each frame may be analyzed by TensorFlow libraries to detect the presence of any human from the pre-trained model. The model may differentiate humans from other moving or static objects based on a configured confidence threshold value. The model may also differentiate a human from other moving or static objects based on the configured confidence threshold value. Once a human is found within the frame, the model will assign tracker identification (ID) for each human identified within the frame. For the same human, the starting position is recorded. Whenever the human moves, the model may update the position of the human accordingly. The algorithm may also virtually configure a line of violation (e.g. boundary 120) at the center of each frame output by the image sensor(s) 334. Alternatively or additionally, the line of violation (e.g. boundary 120) may be configured based on inputs received or processing performed on the server or other computing device.

In some embodiments, an image frame may be processed selectively, depending on whether a human has been detected in the image frame. For example, the image may be processed to determine a position of a human only if a human was detected in the image frame.

Step 704 of example method 700 comprises, selectively, based on the identifying a human in the region, storing at least a portion of the image sensor(s) output. In some embodiments, a portion of the image sensor(s) output may include a snapshot captured upon identifying the human. Alternatively or additionally, the portion may include a stream of image frames that form a video clip.

In some embodiments, step 704 includes the steps shown in FIG. 7B. At step 720 image sensor(s) 334 begin to record a stream of image frame(s) as a video based on determining that the human is represented in the image frames of the stream of image frames. In some embodiments, a video may be recorded as soon as a human is detected in the image frames. In some embodiments, a video may be recorded only if a human crosses one or more boundaries stored in virtual fencing system 300.

Step 722 includes repetitively processing the image frames of the stream of image frames to determine whether the human is represented in the image frames. Image frames may be processed as discussed with respect to step 702 of method 700. Step 724 includes, based on determining that the human is no longer represented in the image frames, ending recording of the stream of image frames.

Example method 700 includes step 706 (FIG. 7A), which includes selectively, based on a comparison of the position parameter to a pre-defined boundary within the region, outputting an indication of an event. In some embodiments, comparing the position parameter to a pre-defined boundary may also include determining a direction of motion of the human by comparing a first position parameter of the human in a first image frame with a second position parameter of the human in a second image frame, as described with respect to step 702.

FIG. 7A shows step 706 following step 704. However, it should be appreciated that these steps need not be performed sequentially. A detection of an event at step 706 may occur once enough image frames have been processed to determine position parameters of a human that correspond to an event. Storing the image frames at step 704 may occur between the time that a human is detected in the image and the human is no longer detected in the image. Further, other steps not expressly illustrated may also be performed. For example, stored image frames may be deleted from memory in response to events, such as the passage of time, storing a large number of additional image frames or detecting that the human as left the image frame with or without an event being detected.

In some embodiments, comparing the position parameter of the human to one or more pre-defined boundaries may include determining if the human crossed any of the boundaries. As described herein, a breach of each boundary may correspond to a different level severity of a safety event. In some embodiments, the indication of the event may include the level of severity of the safety event. In some embodiments, outputting the indication of an event may also include outputting a snapshot captured by the image sensor(s) and/or video recorded by the image sensor(s), as described with respect to step 704.

In some embodiments, outputting an indication of an event may include calling a programming interface 340, as described with respect to FIG. 6. In some embodiments, device 102 will continuously investigate any pre-configured folders for indication of an event. In some embodiments, the programming interface 340 will purge pre-configured folders upon finding data. For example, a first pre-configured folder may include a video recorded of a human in the image frames and a second pre-configured folder may include a snapshot of the human upon entering the image frame or breaching the one or more boundaries. As another example, the pre-configured folders may also contain the level of severity of the event, position parameters of the human within the image frames related to the event, and/or a position of the human with respect to one or more boundaries.

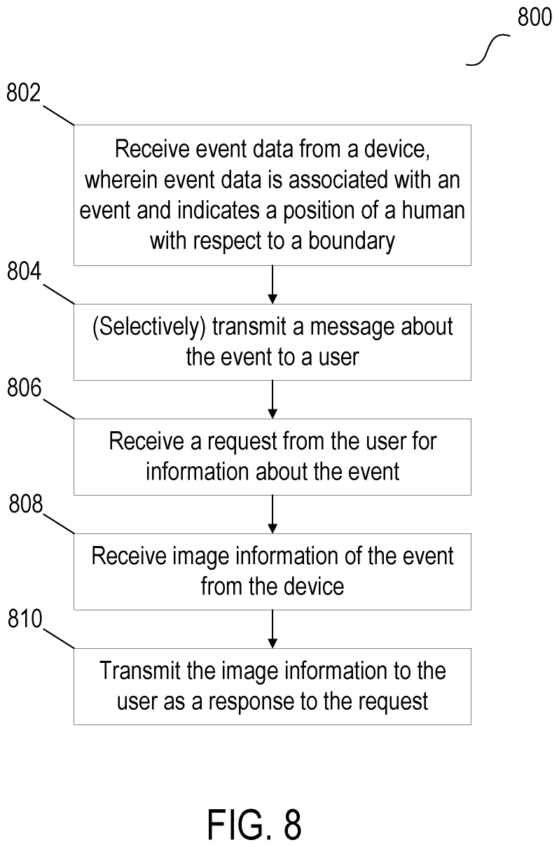

FIG. 8 illustrates an example method 800 for operation on server 152. Step 802 includes receiving event data from a device, wherein event data indicates a position of a human with respect to a boundary. In some embodiments, the position may be indicated in geographic coordinates, such as meters from the boundary or another reference point. Alternatively, position may be indicated based on an indication of a type of event. A warning event, for example, may indicate that the human has been detected near, but not across a boundary. A violation event may indicate that the human's position is across the boundary. Further, in some embodiments there may be multiple types of warning or violation events that may provide additional information about the position of a human. A system may support different types of warning events, and one might indicate that the human is more than a predetermined distance from a boundary but approaching at a speed above a threshold. In some embodiments, the device 102 may update server 152 by transmitting data via a network interface 150.

Based on the event data, step 804 includes sending a message about the event to a user. As described herein, whether a message is sent and/or the content of the message may depend upon a severity level of the event. The severity level of the event may be determined based upon the position parameters of the human with respect to the one or more boundaries, and this determination may be based on processing on device 102 or server 152.

In conjunction with providing a message indicating an event, the server may provide additional information about the event, such as a snapshot of the human involved in the event or a video clip of a portion of the event or a video stream of the environment in which the event is occurring. In some embodiments, the amount of data about an event that server 152 sends to a user may be initially limited. In those embodiments, the amount of information about an event initially sent from a device 102 to server 152 may similarly be limited. For example, in some embodiments, the information sent may include or be limited to a severity level of the event, determined on device 102 based on the position of the human with respect to the boundaries, and this severity level may be presented to the user.

Upon receiving the message, for example, the user may request more information. Step 804 includes receiving the request from the user for more information about the event. In some embodiments, the user may request the information through user interface 332. In some embodiments, information may include a snapshot of the event, as described herein. For example, upon identifying a human in the image frames, processor 336 may store a snapshot. As another example, a snapshot may be captured if the human breaches any of the one or more boundaries. In some embodiments, information may include a video of the event. For example, a video may begin recording when the human enters the image frame and end recording when the human leaves the image frames. As another example, a video may begin recording when a human crosses one or more boundaries and ends when the human crosses the boundaries in the opposite direction or leaves the image frames. A user may request some or all of this additional information.

After receiving the request, step 808 may continue with obtaining information of the event from the device. In some embodiments, the information may correspond to the request received in step 806. In some embodiments, server 125 may send messages containing this information from device 102. For example, the programming interface 340 may be called to obtain the information from the device 102. After obtaining the image information, method 800 proceeds to step 810 to present the information to the user as a response to the request. In some embodiments, the information may be sent to the user interface 332, a personal device, or any other suitable device.

In some embodiments, method 800 may alternatively or additionally include storing the information and event data in the server. In some embodiments, this data may be stored in Cloud Blob storage.

As a non-limiting example of methods 700 and 800, with one or more boundaries configured, the algorithm may analyze movement and a position of a human using tracker ID and determine whether the human touches the line of violation (e.g. boundary 120). The algorithm may analyze the position co-ordinates and determine whether the human is moving in a forward or reverse direction with respect to the line of violation (e.g., boundary 120). In the case that the human nears or crosses the boundary, the algorithm may trigger the intrusion event. Upon triggering the intrusion event, the algorithm may save the image obtained at the time of the intrusion to a local file storage in a pre-configured folder. In some embodiments, the algorithm may start recording a video from the moment the intrusion trigger is activated. Once the human has moved out of the frame, the algorithm in the single board processor will stop recording the video and store the created video clip into a local file storage in a pre-configured folder. In some embodiments, this is different from saving the image file for immediate notification purpose. The transmission module in the virtual fencing control unit may continuously investigate the folder for any new intrusion video clip. In case any such video clip is in the folder, the transmission module may call the API services hosted in the cloud. Once the API is called, the video stored locally may be purged. In some embodiments, an algorithm forms a video clip of a safety violation event or intrusion event and sends the video of the safety violation event to the server through a processing module.

The virtual fencing device may also continuously investigate the folder for any new intrusion event data. In case any such event data is in the folder, the transmission module will call the API services hosted in the cloud. Once the API is called, the local intrusion event-related data will be purged.

When called, in some embodiments, the API may update the server with the latest intrusion event related data. Additionally or alternatively, the API may activate notification services to send a notification to one or more users. In some embodiments, the system may configure the intrusion definition with different severity levels, such as a warning level or a critical level. For example, if the human loiters around the line of violation (e.g., boundary 120), this may be considered a warning level event, while if the human touches the line of violation (e.g., boundary 120) this may be considered a critical level event. In some embodiments, a notification module may include a method to configure the notification to be sent based on the severity of the safety violation or upon detection of a safety violation.

The API in turn may upload the video in the Cloud Blob storage. The application hosted in the cloud may get the data from the blob storage and update the user interface which may be monitored by the user. The videos and images of the intrusion related data may be stored in the Cloud Blob storage for future analysis purpose, which may also be retained for a longer period.

### Example Embodiments

FIGS. 1A-B are schematic illustrations of an example embodiment of the virtual fencing system for monitoring a boundary between a live area and a turnaround area.

In a production plant, there are live areas (e.g., hazardous area 142). In a live area (e.g., hazardous area 142) production activities are ongoing that could potentially be hazardous. As part of the safety protocol, only authorized people are allowed to enter the area. It can be a potential hazard if any unauthorized person enters the live area (e.g., hazardous area 142).

During a turnaround (TA), outage, shutdown or maintenance, a huge workforce may be working in the TA area (e.g., safe area 140). The TA area is the area within the production plant where TA activities occur. These activities may be related to maintenance, upgrading the plant production unit or machineries. During these activities, the plant production unit or machineries are switched off, greatly reducing the presence of hazards. Contractors may only be allowed to enter the TA area (e.g., safe area 140) and are not allowed to enter the live area (e.g., hazardous area 142). If the contractors enter the live area without permission, it is considered a safety breach and will compromise the production plant safety. However, since the live area (e.g., hazardous area 142) may be close to the TA area (e.g., safe area 140), it can be quite challenging to stop the intrusion without physical fencing. However, it is unsafe to build physical fencing around it, as the people must be able to escape easily during an emergency. It is also not productive to build physical fencing as it affects the worker movement.

The virtual fencing (devices 120a-d) can be setup and the line of violation (e.g. boundary 120) can be configured. In the event that the worker moves from the TA area (e.g. safe area 140) to the Live area (e.g. hazardous area 142), it is a safety violation and the operation team of the live area should be alerted of the breach.

In some embodiments, an additional boundary 122 may be configured with devices 120a-d. In the event that the worker moves past this boundary, the operation team of the live area may be alerted or the worker may be alerted. In some embodiments, moving past this boundary may cause a less severe alert to be triggered as a warning that a person is near the line of violation (e.g., boundary 120).

FIGS. 9A-B illustrate another example embodiment of the virtual fencing system for monitoring a boundary between a production plant and areas outside the production plant.

There are areas of the production plant where it is expensive to setup the typical security system due to the lack of electricity and heavy network infrastructures and the huge cost needed to provide them. For example, as shown in FIG. 9B, a company compound with power may be an area of the production plant that has a regular and easily available source of electrical power, while a remote area may be an area within the production plant that is in a remote corner of the facility where electrical power may be absent. Person-managed approach is usually used to ensure plant safety in such situations to prevent people from entering the production plant 942 from outside 940. However, this human-dependent and costly approach will compromise the safety of the production plant.

Virtual fencing device (devices 120a-d) can be setup with the line of violation (e.g. boundary 920) configured. If a human is caught trying to enter the production plant 942 from outside 940 the production plant, a safety violation is detected, and the Health Safety Security Environment team of the production plant will be notified.

In some embodiments, an additional boundary 922 may be configured to with devices 120a-d. In the event that the worker moves past this boundary, the operation team of the production plant may be alerted or the worker may be alerted. In some embodiments, moving past this boundary may cause a less severe alert to be triggered as a warning that a person is near the line of violation (e.g., boundary 920).

FIGS. 10A-B illustrate another example embodiment of the virtual fencing system for monitoring a boundary for a vehicle lane.

In a typical access control system, there are pedestrian and vehicle lane. For the pedestrian lane, the access control for the pedestrian 1044 is controlled by the turnstile or any access control system. For the vehicle lane, the access control for the driver 1046 is controlled by the boom barrier or any vehicle access control system. To prevent pedestrians from trying to enter the industrial plant via the vehicle lane 1042, industrial plants have conventionally used people as security officers to monitor the vehicle lane 1042. This approach is not efficient.

Virtual fencing device (device 102) can be setup with the line of violation (e.g. boundary 1020) configured. In the event that a person is caught trying to enter the industrial plant via the vehicle lane 1042, safety violation is detected, and the Health Safety Security Environment team of the industrial plant will be immediately notified. This detection is autonomous, and this removes the needs of deploying person-managed approaches. This will channel the pedestrian to use the pedestrian access control 1044 and ensure that proper compliance is met while entering the industrial plant.

In some embodiments, an additional boundary 1022 may be configured to with device 120. In the event that a person moves past this boundary, the Health Security Environment team may be alerted, or the person may be alerted. In some embodiments, moving past this boundary may cause a less severe alert to be triggered as a warning that a person is near the line of violation (e.g., boundary 1020).

In some embodiments, the autonomous safety violation detection device may include an algorithm to analyze the presence of a safety violation at the vehicle lane to help channel the human traffic to the designated pedestrian lane to avoid intrusion into the industrial plant via the vehicle lane and to ensure industrial plant safety. This may be used to eliminate the needs of physical barriers and the needs of security guards to monitor the area. In some embodiments, the device may be used at the entrance of an unsafe confined space to prevent the safety violation.

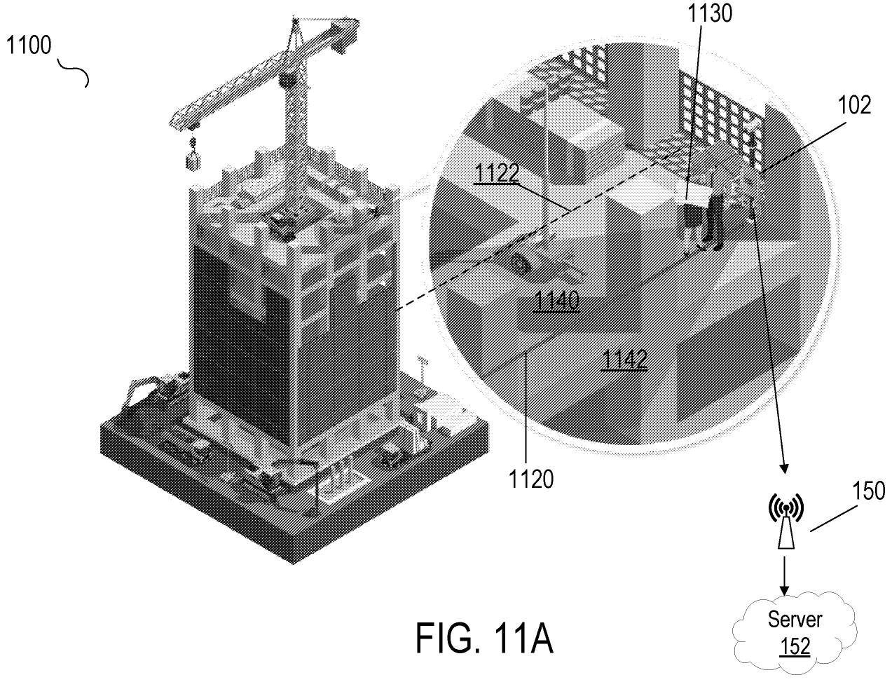

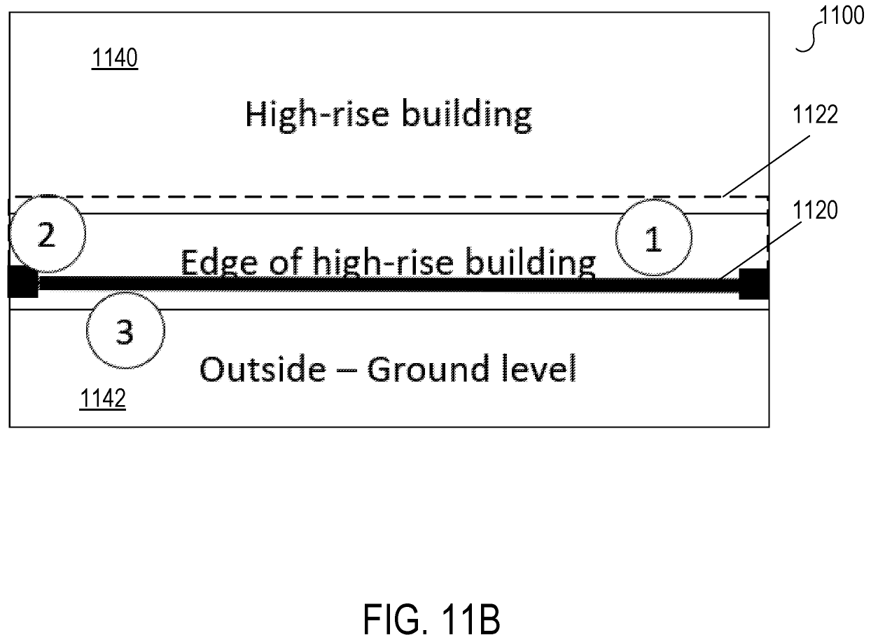

FIGS. 11A-B illustrate another example embodiment of the virtual fencing system for monitoring a hazard associated with a dangerous change in height of a structure.

When humans are working above a certain distance from the ground, they are considered to be working at height and there is a risk of falling from that height. Having a railing or physical protection or man-managed approach is not feasible and efficient. In such event, the risk of falling from height increases as the worker is near the edge of the building 1140.

Virtual fencing device (device 102) can be setup with the line of violation (e.g., boundary 1120) configured. In the event that a human is detected to be closer to the edge (e.g., breached additional boundary 1122) of the high-rise building, a warning safety violation is detected and the visual and audio alarm is triggered, which will warn the human to be cautious and move out of the hazardous area. In the event that a human is detected to be near the edge 1140 of the high-rise building where the line of safety (e.g., boundary 1120) is configured, a critical safety violation is detected. The visual and audio alarm is triggered, and the Health Safety Security Environment team of the building will be notified. The building can be either high-rise building in construction or doing maintenance on a high-rise building in any industrial. This detection is autonomous, and this removes the needs of installing the railings and man-managed approach.

In some embodiments, the autonomous safety violation device may include an algorithm to analyze the presence of a human crossing the line of violation configured at the edge of the building to report the safety violation event and an algorithm to analyze the presence of a human near the line of violation configured at the edge of the building to avoid the potential fall from a height.

### Computing System Environment

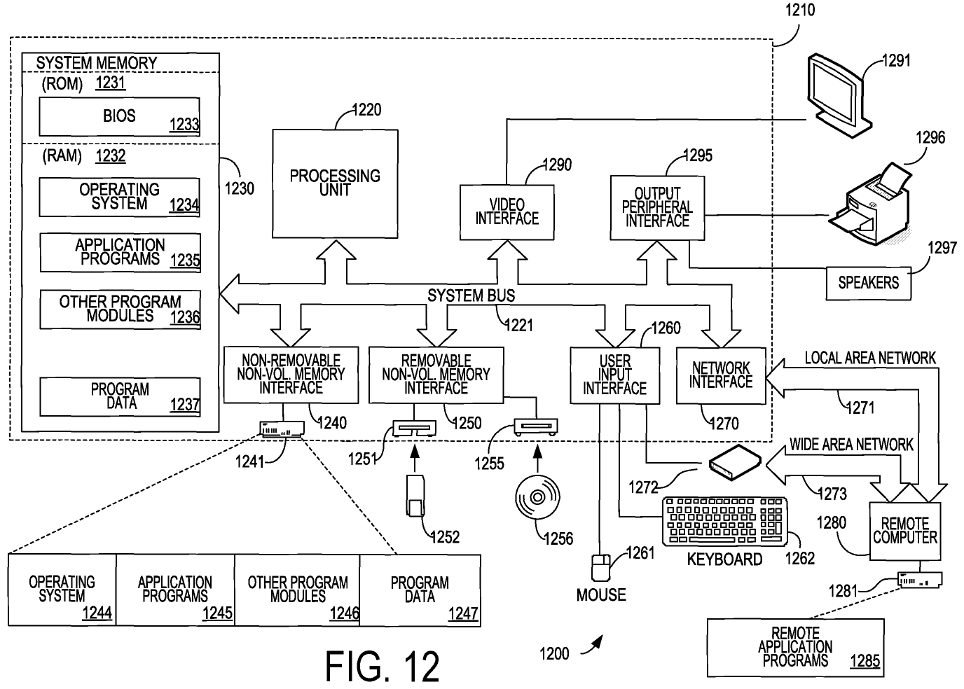

FIG. 12 illustrates an example of a suitable computing system environment 1200 on which embodiments of the technology may be implemented. For example, server 152, processor 336 and/or other computing device used to provide a use interface 332 may be implemented with a computing system as illustrated in FIG. 12.

The computing system environment 1200 is only one example of a suitable computing environment and is not intended to suggest any limitation as to the scope of use or functionality of embodiments of the technology described herein. Neither should the computing environment 1200 be interpreted as having any dependency or requirement relating to any one or combination of components illustrated in the exemplary operating environment 1200.

Embodiments of the technology described herein are operational with numerous other general purpose or special purpose computing system environments or configurations, which may be created by programming a general purpose computing device. Examples of well-known computing systems, environments, and/or configurations that may be suitable for use with embodiments of the technology described herein include, but are not limited to, personal computers, server computers, hand-held or laptop devices, smartphones, tablets, multiprocessor systems, microprocessor-based systems, set top boxes, programmable consumer electronics, network PCs, minicomputers, mainframe computers, distributed computing environments that include any of the above systems or devices, and the like. Some of the elements illustrated in FIG. 12 may not be present, depending on the specific type of computing device. Alternatively, additional elements may be present in some implementations.

The computing environment may execute computer-executable instructions, such as program modules. Generally, program modules include routines, programs, objects, components, data structures, etc. that perform particular tasks or implement particular abstract data types. Embodiments of the technology described herein may also be practiced in distributed computing environments where tasks are performed by remote processing devices that are linked through a communications network. In a distributed computing environment, program modules may be located in both local and remote computer storage media including memory storage devices.

With reference to FIG. 12, an exemplary system for implementing embodiments of the technology described herein includes a general purpose computing device in the form of a computer 1210. Components of computer 1210 may include, but are not limited to, a processing unit 1220, a system memory 1230, and a system bus 1221 that couples various system components including the system memory to the processing unit 1220. The system bus 1221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1210 typically includes a variety of computer readable media. Computer readable media can be any available media that can be accessed by computer 1210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can accessed by computer 1210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1230 includes computer storage media in the form of volatile and/or nonvolatile memory such as read only memory (ROM) 1231 and random-access memory (RAM) 1232. A basic input/output system 1233 (BIOS), containing the basic routines that help to transfer information between elements within computer 1210, such as during start-up, is typically stored in ROM 1231. RAM 1232 typically contains data and/or program modules that are immediately accessible to and/or presently being operated on by processing unit 1220. By way of example, and not limitation, FIG. 12 illustrates operating system 1234, application programs 1235, other program modules 1236, and program data 1237.

The computer 1210 may also include other removable/non-removable, volatile/nonvolatile computer storage media. By way of example only, FIG. 12 illustrates a hard disk drive 1241 that reads from or writes to non-removable, nonvolatile magnetic media, a magnetic disk drive 1251 that reads from or writes to a removable, nonvolatile magnetic disk 1252, and an optical disk drive 1255 that reads from or writes to a removable, nonvolatile optical disk 1256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1241 is typically connected to the system bus 1221 through a non-removable memory interface such as interface 1240, and magnetic disk drive 1251 and optical disk drive 1255 are typically connected to the system bus 1221 by a removable memory interface, such as interface 1250.

The drives and their associated computer storage media discussed above and illustrated in FIG. 12, provide storage of computer readable instructions, data structures, program modules and other data for the computer 1210. In FIG. 12, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237. Operating system 1244, application programs 1245, other program modules 1246, and program data 1247 are given different numbers here to illustrate that, at a minimum, they are different copies. A user may enter commands and information into the computer 1210 through input devices such as a keyboard 1262 and pointing device 1261, commonly referred to as a mouse, trackball or touch pad. Other input devices (not shown) may include a microphone, joystick, game pad, satellite dish, scanner, or the like. These and other input devices are often connected to the processing unit 1220 through a user input interface 1260 that is coupled to the system bus, but may be connected by other interface and bus structures, such as a parallel port, game port or a universal serial bus (USB). A monitor 1291 or other type of display device is also connected to the system bus 1221 via an interface, such as a video interface 1290. In addition to the monitor, computers may also include other peripheral output devices such as speakers 1297 and printer 1296, which may be connected through an output peripheral interface 1295.

The computer 1210 may operate in a networked environment using logical connections to one or more remote computers, such as a remote computer 1280. The remote computer 1280 may be a personal computer, a server, a router, a network PC, a peer device or other common network node, and typically includes many or all of the elements described above relative to the computer 1210, although only a memory storage device 1281 has been illustrated in FIG. 12. The logical connections depicted in FIG. 12 include a local area network (LAN) 1271 and a wide area network (WAN) 1273, but may also include other networks. Such networking environments are commonplace in offices, enterprise-wide computer networks, intranets and the Internet.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. The modem 1272, which may be internal or external, may be connected to the system bus 1221 via the user input interface 1260, or other appropriate mechanism. In a networked environment, program modules depicted relative to the computer 1210, or portions thereof, may be stored in the remote memory storage device. By way of example, and not limitation, FIG. 12 illustrates remote application programs 1285 as residing on memory device 1281. It will be appreciated that the network connections shown are exemplary and other means of establishing a communications link between the computers may be used.

Having thus described several aspects of at least one embodiment of this technology, it is to be appreciated that various alterations, modifications, and improvements will readily occur to those skilled in the art.

Such alterations, modifications, and improvements are intended to be part of this disclosure and are intended to be within the spirit and scope of embodiments of the technology. Further, though advantages of embodiments of the technology are indicated, it should be appreciated that not every embodiment of the technology will include every described advantage. Some embodiments may not implement any features described as advantageous herein. Accordingly, the foregoing description and drawings are by way of example only.

The above-described embodiments of the technology can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format. In the embodiment illustrated, the input/output devices are illustrated as physically separate from the computing device. In some embodiments, however, the input and/or output devices may be physically integrated into the same unit as the processor or other elements of the computing device. For example, a keyboard might be implemented as a soft keyboard on a touch screen. Alternatively, the input/output devices may be entirely disconnected from the computing device, and functionally integrated through a wireless connection.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, embodiments of the technology may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the technology discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present technology as discussed above. As used herein, the term “computer-readable storage medium” encompasses only a computer-readable medium that can be considered to be a manufacture (i.e., article of manufacture) or a machine. Alternatively or additionally, embodiments of the technology may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present technology may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, embodiments of the technology described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for configuring a virtual fencing system comprising an image sensor, the method comprising:
presenting an image on a user interface of a computing device, the image having been captured using the image sensor;
receiving through the user interface a boundary; and
storing, in connection with the image sensor, a plurality of boundaries, including the boundary, wherein each of at least some of the plurality of boundaries corresponds to a respective level of a plurality of levels of an alert system.

2. The method of claim 1,
wherein the virtual fencing system comprises a device, the device comprising:
the image sensor;
non-volatile memory; and
a processor, coupled to the image sensor and the non-volatile memory, the processor configured to detect a human in an image captured using the image sensor, and wherein the method further comprises storing the boundary in the non-volatile memory.

3. (canceled)

4. The method of claim 1, wherein:
a first level of the alert system comprises an alert indicating a presence of a human in proximity of the boundary; and
a second level of the alert system comprises an alert indicating a breach of the boundary.

5. The method of claim 2, wherein:
the device comprises a network interface; and
the method further comprising configuring the device to communicate through the network interface to a server.

6. A method of operating a device comprising a sensor to implement a virtual fence, wherein the sensor is configured to output a stream of image frames, the method comprising:
processing output of the sensor to:
identify a human in the region; and
compute at least one position parameter of the human in the region;
selectively, based on identifying the human in the region, storing sensor output at least in part by storing a portion of the stream of image frames following at least one image frame of the stream of image frames in which the human is represented; and
selectively, based on a comparison of the at least one position parameter to a boundary within the region, outputting an indication of an event.

7. (canceled)

8. The method of claim 6, wherein:
storing the portion of the stream of image frames comprises recording the portion of the stream of image frames as a video, and
selectively storing the sensor output further comprises:
repetitively processing image frames of the stream of image frames to determine whether the human is represented in the image frames; and
based on determining that the human is no longer represented in the image frames, ending recording of the stream of image frames.

9. The method of claim 6, wherein computing the at least one position parameter of the human comprises detecting a direction of motion of the human.

10. The method of claim 6, wherein the comparison of the at least one position parameter to the boundary comprises determining whether the human breached the boundary.

11. The method of claim 6, wherein outputting the indication of the event comprises transmitting an indication of a safety violation in conjunction with at least a portion of the stored sensor output.

12. The method of claim 11, wherein the portion of the stored sensor output comprises a snapshot representing the human.

13. The method of claim 6, wherein the comparison of the at least one position parameter to the boundary comprises determining whether the human is in proximity to the boundary.

14. The method of clam 6, wherein outputting the indication of the event comprises activating an audible output device and/or a visible output device.

15. The method of claim 6, wherein outputting the indication of the event comprises electronically transmitting a message comprising a warning of a safety violation.

16. The method of claim 6, wherein:
the region comprises a facility entrance comprising a pedestrian lane and a vehicle lane;
the boundary is positioned between the pedestrian lane and the vehicle lane; and
outputting the indication of the event comprises outputting an indication that the human has breached the boundary and/or entered the vehicle lane.

17-20. (canceled)

21. A device configured for implementing a virtual fence, the device comprising:
one or more image sensors configured to output image frames;
at least one processor coupled to the one or more image sensors; and
a non-transitory computer-readable storage medium storing:
a boundary;
processor executable instructions that, when executed by the at least one processor, cause the at least one processor to perform:
identifying a human in an image frame output by the one or more image sensors;
computing at least one position parameter of the human based on a result of the identifying; and
selectively transmitting a message based on a comparison of the at least one position parameter to the boundary; and
selectively storing a plurality of image frames output by at least one image sensor of the one or more image sensors based at least in part on the at least one position parameter.

22. The device of claim 21, wherein:
the at least one processor comprises a single-board processor; and
the non-transitory computer-readable storage medium comprises non-volatile memory on the single-board processor.

23. The device of claim 21, wherein the one or more image sensors comprise at least one of a visible light sensor, an infrared radiation sensor, an ultrasonic sensor, a LIDAR sensor, a RADAR sensor, and a laser sensor.

24. The device of claim 21, wherein:
the device further comprises a physical output device; and
the processor-executable instructions further cause the at least one processor to perform:
selectively activating the physical output device based at least in part on the at least one position parameter.

25. The device of claim 21, wherein the processor-executable instructions further cause the at least one processor to perform:
selectively transmitting the stored plurality of image frames based on the comparison of the at least one position parameter to the boundary.

26. The device of claim 21, wherein the processor-executable instructions further cause the at least one processor to perform:
selectively transmitting a plurality of image frames output by at least one image sensor of the one or more image sensors as a video stream based on the comparison of the at least one position parameter to the boundary.
